(19) United States
(12) Patent Application Publication
(10) Pub. No.: US 2013/0343266 A1
(43) Pub. Date: Dec. 26, 2013

(54) SYSTEM AND METHOD FOR UPDATING SOFTWARE

(71) Applicant: TURNING TECHNOLOGIES, LLC, Youngstown, OH (US)

(72) Inventors: Jonathan A. HALLSTEN, Barberton, OH (US); Steven R. NELSON, Youngstown, OH (US)

(73) Assignee: TURNING TECHNOLOGIES, LLC, Youngstown, OH (US)

(21) Appl. No.: 13/680,886

(22) Filed: Nov. 19, 2012

Related U.S. Application Data
(60) Provisional application No. 61/663,166, filed on Jun. 22, 2012.

(51) Int. Cl. H04W 4/00

(52) U.S. Cl. CPC H04W 4/00
USPC 370/328

(57) ABSTRACT

A method of providing a software update to a plurality of transmission devices includes receiving, by a processor, a first information signal containing a first transmission device identifier, a first transmission device hardware version identifier, and a first software version identifier. The method further includes wirelessly transmitting a first plurality of data packets in series, wherein each of the first plurality of data packets includes one of a set of data packet identifiers and a portion of an update to software corresponding to the first software version identifier. The method also includes receiving, by the processor, at least one data packet acknowledgment and wirelessly transmitting a second plurality of data packets. The second plurality of data packets includes at least one previously transmitted data packet for which a data packet acknowledgment has not been received by the processor.

### CROSS REFERENCE TO RELATED APPLICATIONS

This application claims priority to U.S. Provisional Application No. 61/663,166, filed on Jun. 22, 2012. The disclosure of this application is incorporated by reference herein in its entirety.

### FIELD OF INVENTION

The present disclosure relates to a system and method for updating software. More particularly, the present disclosure relates to a wireless audience response system having at least one base unit and a plurality of handheld response units, and a method for updating software on the same.

### BACKGROUND

Audience response systems are employed to retrieve (or receive) responses from a group of individuals at a central location. Such systems may be used in classroom settings, corporate meetings, or in other gatherings of individuals. Wireless audience response systems may include at least one base unit and a plurality of handheld units. Each handheld unit typically includes a keypad for inputting user responses.

In one known embodiment, an audience response system may include different hardware versions of handheld units. When software updates become available, the handheld units are plugged into a computer to receive the update.

### SUMMARY OF THE INVENTION

In one embodiment, a method of providing a software update to a plurality of transmission devices includes receiving, by a processor, a first information signal containing a first transmission device identifier, a first transmission device hardware version identifier, and a first software version identifier. The method further includes wirelessly transmitting a first plurality of data packets in series, wherein each of the first plurality of data packets includes one of a set of data packet identifiers and a portion of an update to software corresponding to the first software version identifier. The method also includes receiving, by the processor, at least one data packet acknowledgment and wirelessly transmitting a second plurality of data packets. The second plurality of data packets includes at least one previously transmitted data packet for which a data packet acknowledgment has not been received by the processor.

In another embodiment, an audience response system includes a transmission device having a first transmission device identifier, a first transmission device hardware version, and a first software version. The transmission device is configured to transmit a first information signal that includes the first transmission device identifier, a first hardware version identifier corresponding to the first transmission device hardware version, and a first software version identifier corresponding to the first software version. The transmission device is further configured to transmit an acknowledgment signal in response to receiving data packets. A base unit configured to receive the first information signal and transmit a first plurality of data packets, wherein each of the first plurality of data packets includes one of a set of data packet identifiers and a portion of an update to software corresponding to the first software version identifier. The base unit is further configured to receive a plurality of data packet acknowledgments. The base unit is also configured to transmit a second plurality of data packets, including at least one previously transmitted data packet for which a data packet acknowledgment has not been received by the base unit.

In still another embodiment, an audience response system includes a base unit configured to transmit a plurality of data packets, each data packet including a data packet identifier, and a portion of a software update. The audience response system also includes at least one handheld device having a transceiver configured to receive the plurality of data packets, a memory having a software stored thereon, and a processor. The processor is configured to erase the software and store each received data packet in the memory of the handheld device. The processor is further configured to, after storing a predetermined number of data packets, decrypt each data packet, and rewrite the decrypted data packet to the memory.

In yet another embodiment, a method of providing a software update to a plurality of transmission devices includes receiving, by a processor, a first information signal containing a first transmission device identifier, a first transmission device hardware version identifier, and a first software version identifier. The method further includes wirelessly transmitting a first plurality of data packets in series and receiving, by the processor, at least one data packet acknowledgment. The method also includes wirelessly transmitting a second plurality of data packets in series. The second plurality of data packets includes at least one previously transmitted data packet for which a data packet acknowledgment has not been received by the processor. The wirelessly transmitting the first plurality of data packets in series and the wirelessly transmitting the second plurality of data packets in series includes wirelessly transmitting at least one data packet at a first transmission rate, and wirelessly transmitting at least one data packet at a second transmission rate different from the first transmission rate.

### BRIEF DESCRIPTION OF DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes in the figures) represent one example of the boundaries. One of ordinary skill in the art will appreciate that one element may be designed as multiple elements or that multiple elements may be designed as one element. An element shown as an internal component of another element may be implemented as an external component and vice versa. The drawings may not be to scale and the proportion of certain elements may be exaggerated for the purpose of illustration.

FIG. 1 is a simplified front plan view of one embodiment of a handheld unit for a wireless response system;

FIG. 2 is a simplified front plan view of one embodiment of a base unit for a wireless response system;

FIG. 3 is a simplified schematic drawing of components of one embodiment of a handheld unit in communication with a base unit;

FIG. 4 is a simplified schematic drawing of components of one embodiment of a base unit in communication with a plurality of handheld units;

FIGS. 5A-G are schematic drawings showing stages of one embodiment of a software update, as the updated software is stored in a memory of a handheld unit;

FIGS. 6A-D are schematic drawings of exemplary transmissions of data packets.

FIG. 7 is a simplified flow chart of one embodiment of a method performed by a handheld units for updating its software;

FIG. 8 is a simplified flow chart of one embodiment of a method performed by a base unit for updating software of a plurality of handheld units; and

FIG. 9 is a simplified flow chart of one embodiment of a general method for transmitting software.

### DETAILED DESCRIPTION

“Computer-readable medium,” as used herein, refers to any tangible medium that participates directly or indirectly in providing signals, instructions and/or data to one or more processors for execution. Such a medium may take many forms, including but not limited to, non-volatile media, volatile media, and transmission media. Non-volatile media may include, for example, optical disks, magnetic disks or so-called “memory sticks.” Volatile media may include dynamic memory. Transmission media may include coaxial cables, copper wire, and fiber optic cables. Transmission media can also take the form of acoustic or light waves, such as those generated during radio-wave and infra-red data communications, or take the form of one or more groups of signals. Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, a PROM, an EPROM, an EEPROM, a FLASH-EPROM, phase change memory, any other memory chip or cartridge, a carrier wave/pulse, or any other medium from which a computer, a processor or other electronic device can read.

“Logic,” as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmed logic device, memory device containing instructions, or the like. Logic may also be fully embodied as software.

“Signal,” as used herein, includes but is not limited to one or more electrical or optical signals, analog or digital signals, one or more computer or processor instructions, messages, a bit or bit stream, or other means that can be received, transmitted, and/or detected.

“Software,” as used herein, includes but is not limited to one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“User,” as used herein, includes but is not limited to one or more persons, software, computers or other devices, or combinations of these.

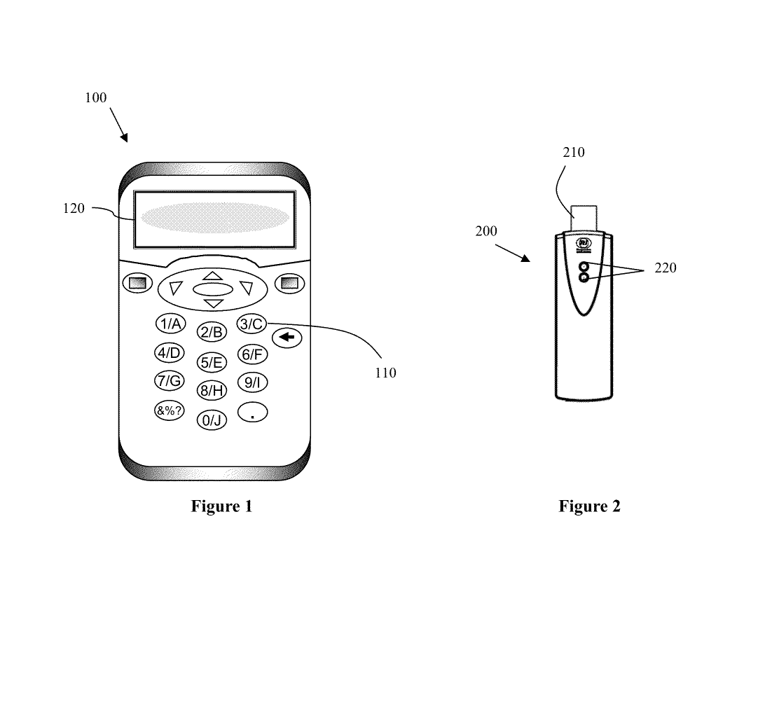

FIG. 1 illustrates a front plan view of one embodiment of a handheld unit 100 for a wireless response system. In the illustrated embodiment, the handheld unit 100 includes a plurality of buttons 110 configured to accept a user input. In alternative embodiments, the handheld unit may employ switches, dials, an LCD touch screen, a graphical user interface, or any other known interface configured to accept a user input.

In the illustrated embodiment, the handheld unit 100 further includes a display 120, such as an LCD display. In alternative embodiments, the handheld device may employ indicator lights (such as light emitting diodes), or other displays. In another alternative embodiment, the handheld device does not include a display.

FIG. 2 illustrates a front plan view of one embodiment of a base unit 200 for a wireless response system. In the illustrated embodiment, the base unit 200 includes a connector 210 configured to be connected to a port of a computer. In an alternative embodiment, the base unit may wirelessly communicate with a computer via an infrared or RF transmitter. In another alternative embodiment, the base unit does not directly connect to a computer.

The base unit 200 includes at least one LED 220. The LED 220 may be configured to indicate on/off status and transmission status. In alternative embodiments, the base unit may employ a dial, an LCD screen, or other known indicators. In another alternative embodiment, the base unit does not include any indicators.

In one embodiment, the base unit 200 further includes a computer-readable medium that allows a user to store data. In such an embodiment, the base unit 200 may also function as a flash drive or thumb drive.

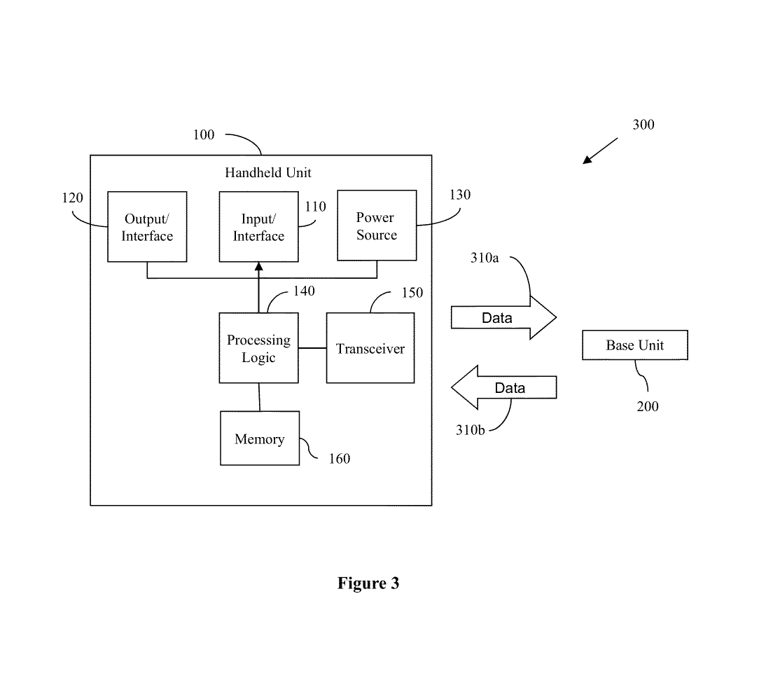

FIG. 3 illustrates one embodiment of a wireless response system 300. In the illustrated embodiment, the system 300 includes at least one handheld unit 100 and at least one base unit 200. The handheld unit 100 includes the plurality of buttons 110 described above that act as an input interface. Alternatively, the input interface may include a keypad, an LCD touchpad, dials, toggle switches, levers, knobs, buttons, or any other appropriate control or input mechanisms.

The handheld unit 100 also includes an output interface 120. In one embodiment, the output interface 120 indicates operating status to a user such as: a signal is being transmitted, an acknowledgment has been received, user entry has been confirmed, and a software update is being received. In such an embodiment, one or more LEDs, an LCD, or other display may serve as an output interface 120. In an alternative embodiment (not shown), the output interface does not provide indication of the software update. In another alternative embodiment (not shown), the handheld unit does not include an output interface.

The handheld unit 100 also has a power source 130, such as a battery. The handheld unit 100 further includes processing logic 140 and a wireless data transceiver 150, such as a radio frequency (RF) transceiver configured to transmit RF signals as shown at 310a and receive RF signals as shown at 310b. In an alternative embodiment (not shown), the handheld unit may include an RF transmitter, but not a receiver or a transceiver. In another alternative embodiment (not shown), the handheld unit may include an infrared (IR) source configured to transmit data and/or an IR sensor configured to receive data.

The input interface 110 is in communication with processing logic 140. When a user inputs a selection into the input interface 110, the user selection is communicated to the processing logic 140. The processing logic 140 then generates and formats a signal for transmission by the transceiver 150. In one embodiment, the signal includes a stored address and the user selection. The address may be a number, a sequence of alphanumeric characters, a sequence of ASCII characters, and the like. In one embodiment, the address is permanently assigned to a handheld unit 100.

The processing logic 140 is in signal communication with one or more computer-readable media, shown in FIG. 3 as a memory 160. The memory 160 is used for data storage purposes, such as to store user responses and the address of the handheld unit 100. The memory 160 also stores the application software and associated executable files, such as bootstrap loader (“BSL”) software, USB display software, over-the-air RAM software, and USB RAM software, that are executed by the processing logic 140 to perform the audience response functions described above. Although the memory 160 is shown schematically as a single box, it should be understood that several computer-readable media may constitute the memory 160.

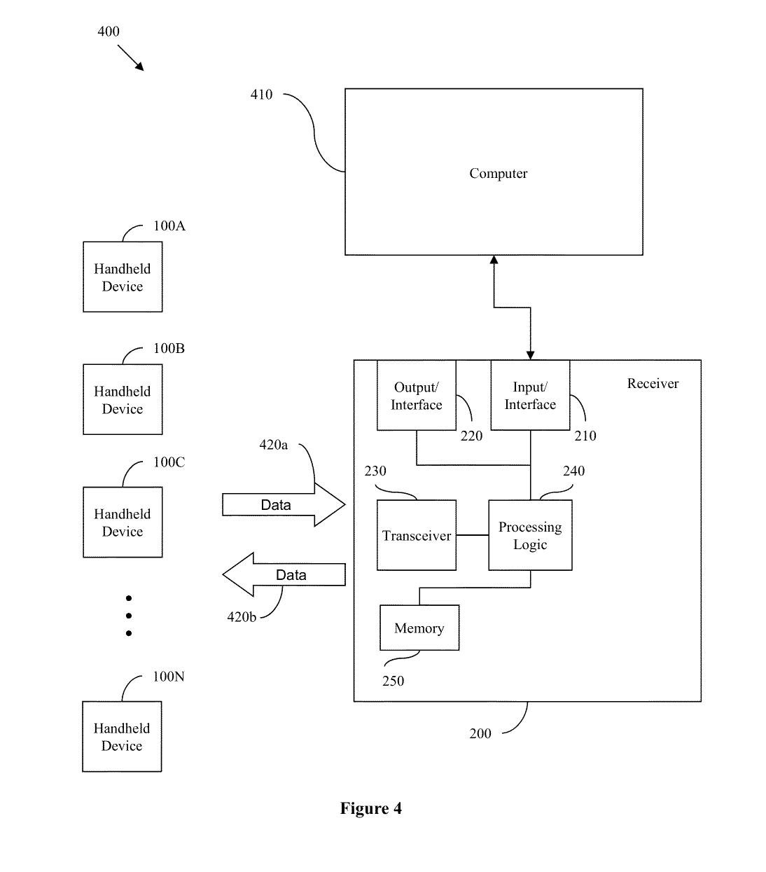

FIG. 4 illustrates a simplified schematic drawing of one embodiment of a wireless response system 400, having a base unit 200 in communication with a plurality of handheld units 100A-N. The handheld units 100A-N may be substantially the same as the handheld units 100 described above. It should be understood that the base unit 200 may be in data communication with a single handheld unit or many handheld units.

As shown in FIG. 4, the base unit 200 includes an input/interface such as the connector 210 that is in signal communication with a computer 410. In an alternative embodiment (not shown), the base unit may be a stand alone device that is not connected to an external computer.

The base unit 200 further includes an output/interface, such as the LED 220. In alternative embodiments, the base unit may employ an LCD screen or other known displays and indicators.

The base unit 200 also has an RF transceiver 230 configured to receive an RF signal as shown at 420a and send an RF signal as shown at 420b. In an alternative embodiment (not shown), a base unit may have multiple transceivers. In one such embodiment, a first transceiver may be used for software updates while a second transceiver performs polling operations. Alternatively, multiple transceivers may be performing the same operation. In another alternative embodiment (not shown), the base unit may include an RF receiver, but not a transmitter or a transceiver. In still another alternative embodiment (not shown), the base unit may include an infrared (IR) sensor configured to receive data and/or an IR source configured to transmit data.

The transceiver 230 is in signal communication with processing logic 240. In this embodiment, when a signal is received by the RF transceiver, it is communicated to the processing logic 240, which decodes and parses the signal.

In one embodiment (not shown), the base unit may have an ID. The processing logic may be configured to only accept signals that contain the base unit ID, thus ensuring that any collected data is not skewed by spurious signals. In one embodiment, a replacement base unit may have the same ID as a first base unit. In such an embodiment, the replacement base unit would accept signals from the handheld units, without the need for reprogramming the handheld units. In another embodiment, all manufactured base units may have the same ID.

After the signal has been successfully decoded and parsed, the processing logic 240 may generate an acknowledgment signal that contains, for example, the address and an acknowledgment indicator. The acknowledgment signal may also include an indication of whether the user selection was accepted.

With continued reference to FIG. 4, the base unit 200 also includes a computer-readable medium such as a memory 250, configured, for example, as RAM, Flash, EEPROM, or other types of writable memory. In one embodiment, the user selection and/or the address are stored in the memory 250 after the signal has been decoded and parsed by the processing logic 240. The storing of the user selection and/or the address may occur before, after, or concurrently with the transmission of the acknowledgment signal. In an alternative embodiment (not shown), the base unit does not have a writable memory and the user selection and unique identifier are instead only communicated to an external computer.

The base unit 200 may also be employed to transmit software updates to the handheld units 100 that are in an update mode. Software updates may be transmitted as a “forced update,” in which software updates are transmitted by the base unit 200 to the handheld units 100 that are within range and are in the update mode. Software updates may also be transmitted as an “optional update,” in which the handheld unit 100 prompts the user to receive the software update. In such an embodiment, software updates are transmitted by the base unit 200. If the user takes a positive action to receive the update, such as pushing a button, the handheld unit 100 is transitioned to an update mode to receive the software update. But if the user has not taken the positive action, the handheld unit 100 does not receive the update.

In both the forced update and optional update embodiment, a handheld unit 100 may be determined to be ineligible for a software update. For example, if a handheld unit has a battery life below a predetermined threshold, it will be ineligible. Other examples of ineligible units include units that have already received the software update, and units that are not on an update list. The ineligible handheld unit will be transitioned out of the update mode, or will not have been placed in the update mode at all.

During a software update, the handheld unit may indicate to the user that it is receiving an update. For example, an LED may flash a predetermined color or in a predetermined sequence. Alternatively, where the handheld unit includes a display, the handheld unit may display a message that a software update is in progress. In one embodiment, the message may include a progress bar that indicates an amount of time left for the update. Alternatively, the handheld unit may not provide an indication of the update.

To begin the software update process, each handheld unit 100 transmits an initial signal so that the base unit 200 is aware of all of the handheld units 100 that are present. The initial signal may be a signal containing a user selection based on a response to a question in an ongoing audience response session. Alternatively, the signal may be an initial wake up signal transmitted by the handheld unit 100 when it is first powered on. In another alternative embodiment, a user may press a specified button, or a specified sequence of buttons to send a software update request. In yet another alternative embodiment, a user may press any button or sequence of buttons to send any signal from the handheld unit to the base unit. In some of the above-described embodiments, the presence of a signal rather than the content of the signal is all that is required. In other embodiments, the signal must contain a request for a software update.

After the base unit 200 receives the initial signal, it transmits an acknowledgment, indicating that a software update is available and that the handheld unit 100 is requested to send additional information. After the handheld unit 100 receives the acknowledgment, it transmits additional information. The additional information may include, without limitation, language, a software version, a BSL version, a model number, a unique address, a hardware version number, and battery level.

After the base unit 200 receives the additional information, it determines whether the handheld unit 100 is eligible to receive an update. For example, the base unit 200 may determine that the handheld unit 100 does not have enough battery life to receive and install the update. Or the base unit 200 may determine, based on the unique address, that the handheld unit 100 has already received the update or is otherwise not eligible to receive the update.

Additionally, in some instances, all or part of the software update may only be compatible with certain hardware versions of the handheld units. In such cases, the base unit 200 determines which portions of software updates should be sent, based on the hardware version numbers received.

Although certain steps in the above initialization process were described as being performed by the base unit 200, it should be understood that one or more such steps may be performed by an external computer 400 in signal communication with the base unit 200.

After the initialization process, the base unit 200 begins transmitting the software update. However, it should be understood that initialization processes may continue while the software update is transmitted. For example, new users may enter the room while the software update is in process. As a new handheld unit becomes within range of the base unit 200, the new handheld unit may go through the initialization process even though the software update for other handheld units is already underway.

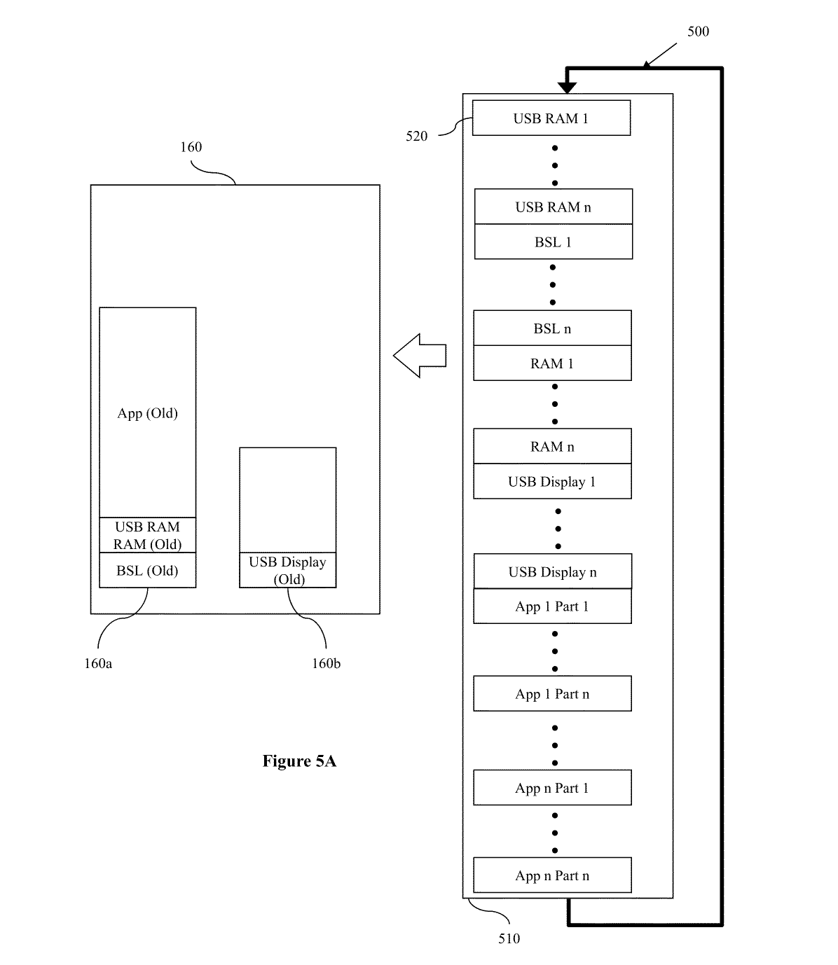

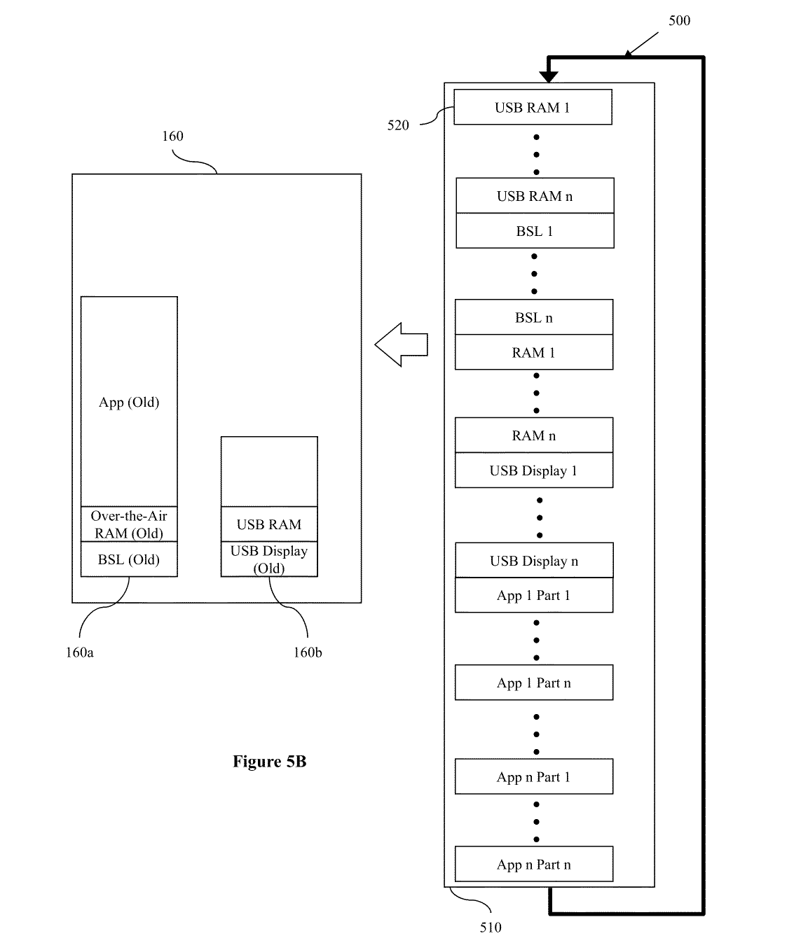

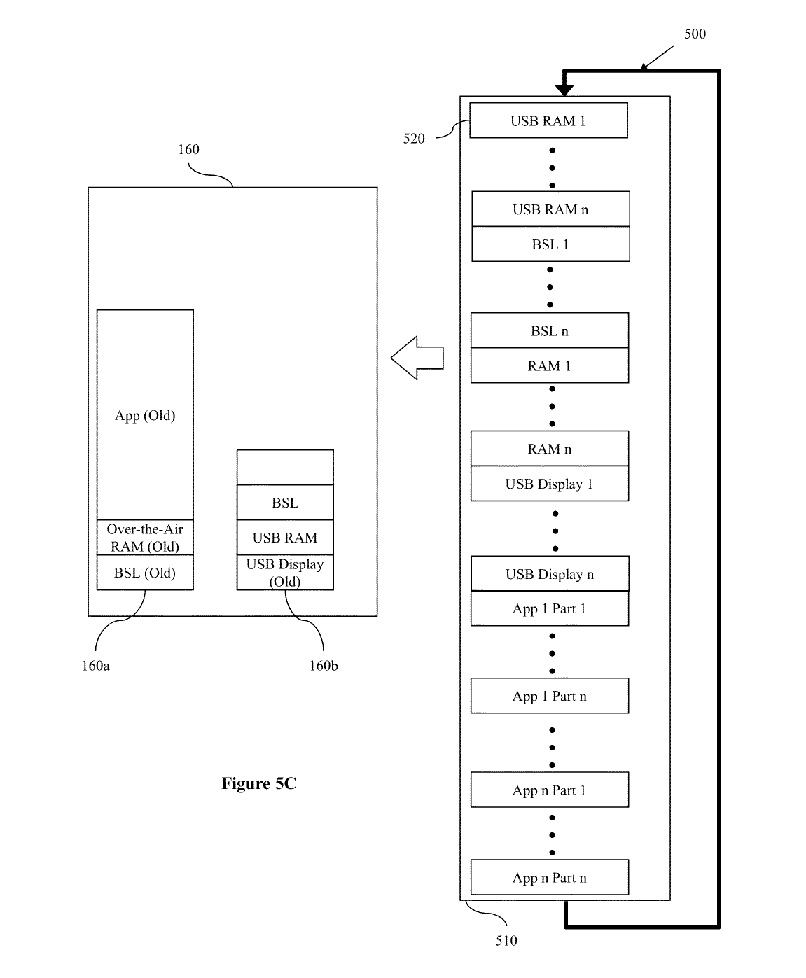

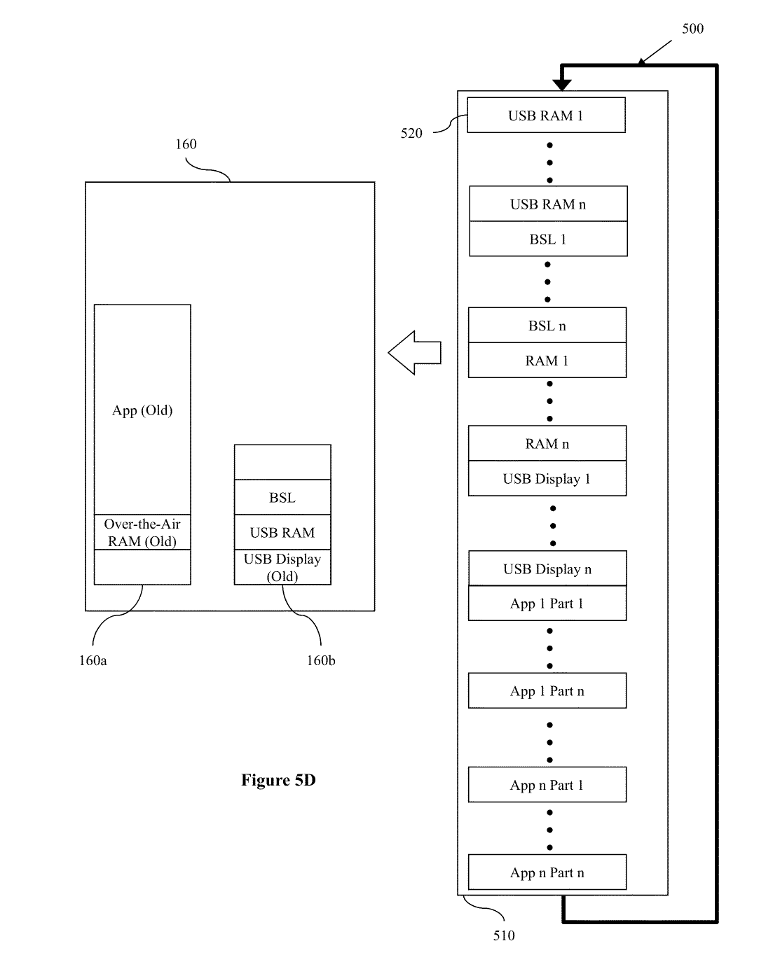

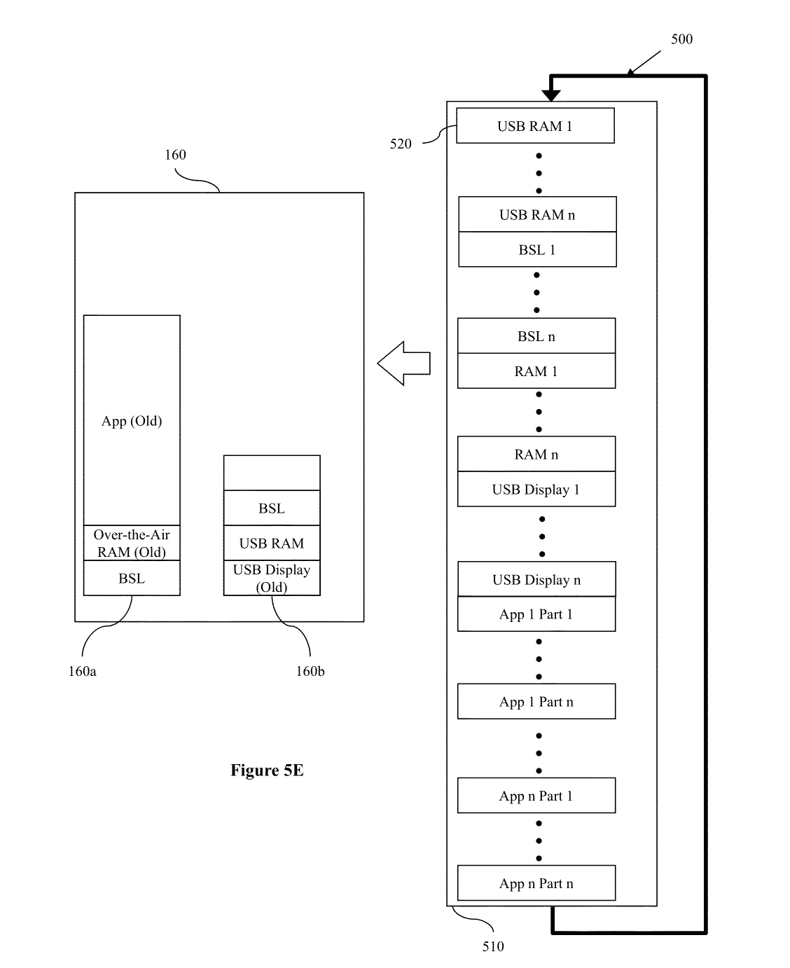

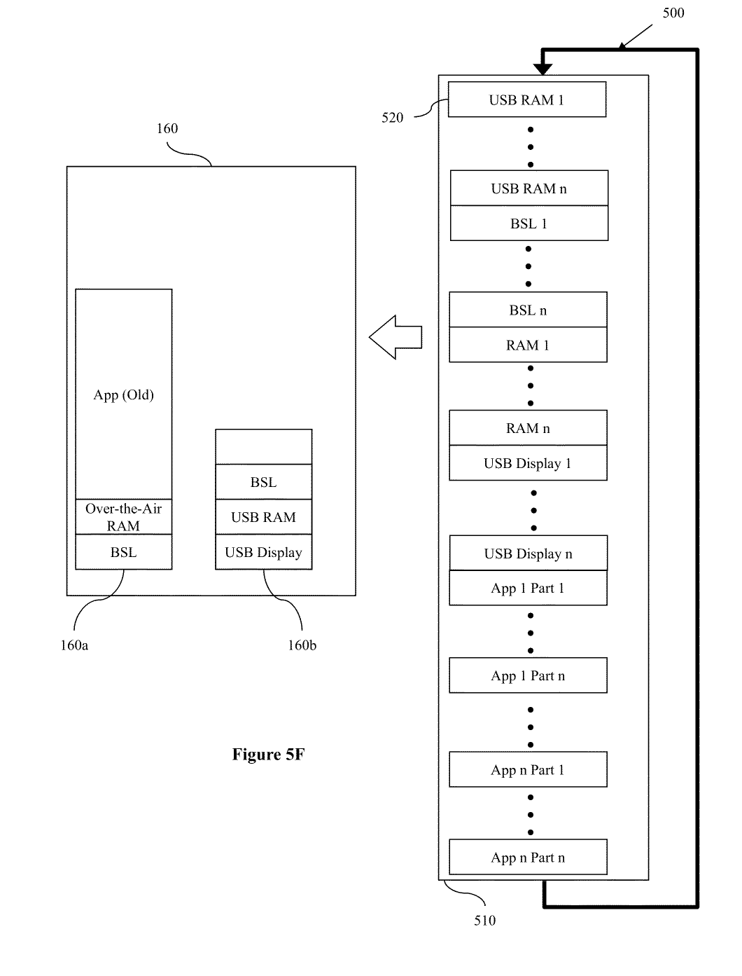

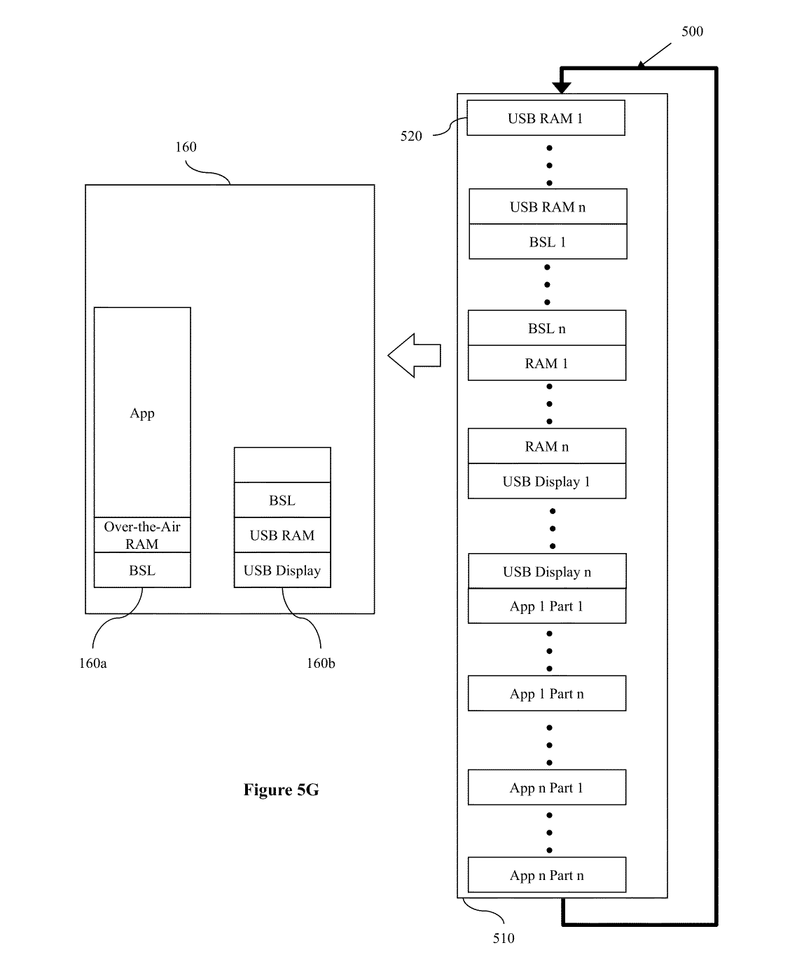

FIGS. 5A-H are schematic drawings showing stages of an exemplary software update 500, as the updated software is stored in a memory 160 of a handheld unit. In the illustrated embodiment, the memory 160 includes a first computer-readable medium 160a and a second computer-readable medium 160b. In one embodiment, the first computer-readable medium 160a is Flash memory, having a capacity of 130 kB and the second computer-readable medium 160b is an EEPROM having a capacity of 16 kB. However, it should be understood that any number and type of computer-readable media may be employed, and that a storage size may be selected that is appropriate for the size of files that are to be received.

FIGS. 5A-H further illustrate a data transmission 510 from a base unit 200 that includes a plurality of discrete data packets 520. The discrete data packets 520 include all of the required versions of USB RAM software, all of the required versions of USB display software, all of the required versions of BSL software, all of the required versions of over-the-air RAM software, and all of the required versions of the application software. Although the data packets 520 are illustrated in a particular series, it should be understood that they may be transmitted in any order. In one embodiment, the base unit 200 enters a non-transmission mode after the transmission of each data packet 520. During the non-transmission period, the base unit 200 may receive signals from the handheld units 100, such as acknowledgment signals. In one embodiment, each handheld unit 100 transmit an acknowledgment signal upon receipt of each data packet. The acknowledgment signal includes an identification of the specific packet received. Additionally, or alternatively, each handheld unit transmits an acknowledgment signal upon writing the received data packet to a memory, upon decrypting the data packet, or upon verifying the data packet. In another alternative embodiment, the handheld units send an acknowledgment signal upon reaching predetermined milestones. For example, a handheld unit may transmit an acknowledgment signal to indicate that it has received 100 data packets, 200 data packets, etc. In another example, certain data packets may be grouped together, and the handheld unit transmits an acknowledgment when all of the data packets of a predefined group have been received.

In an alternative embodiment, the base unit 200 may receive signals from the handheld units 100 at the same time that it is transmitting the data packets 520. For example, the base unit may have multiple transceivers, with at least one transceiver dedicated to polling operations.

The acknowledgments may be used to display a progress of the software update. The base unit 200 may display the progress, or transmit data to an external computer that displays the progress. Based on the acknowledgments received, the status of an individual handheld unit may be determined. Likewise, the status of a group of handheld units may be determined based on the acknowledgments received.

In one embodiment, the base unit 200 has the ability to transmit data at different rates. For example, the base unit may be configured to transmit data at a rate of 250 kilobytes per second (kbps), 1 megabyte per second (1 mbps), or 2 mbps. As one of ordinary skill would understand, data is transmitted faster when it is transmitted at a higher rate, but is more susceptible to loss at greater distances. Accordingly, the base unit 200 may be configured to vary the transmission rate based on the number of acknowledgment signals it receives. If the base unit receives fewer acknowledgment signals than expected, it may transmit the data packets at a slower transmission rate. In one embodiment, the base unit begins to transmit all data packets at a slower transmission rate upon determining that the number of acknowledgment signals received is below a predetermined threshold. In an alternative embodiment, the base unit identifies a specific data packet that has not been received, and retransmits that specific data packet at slower transmission rate, while maintaining the transmission rate of other data packets. Additionally, or alternatively, the transmission rate may be determined based on the hardware version of the handheld unit. For example, it may be known that certain versions of handheld units are capable of receiving transmissions at a first rate, while certain other versions of handheld units are capable of receiving transmissions at a second rate.

FIG. 5A illustrates a memory 160 prior to receiving a software update. In the illustrated embodiment, the first computer-readable medium 160a is storing an old version of the application software, an old version of over-the-air RAM software, and an old version of the BSL software. In ordinary operation, processing logic 240 executes the BSL software, which contains executable instructions for verifying and executing the application. The application contains executable instructions for receiving user selections, storing and transmitting the selections, and receiving and storing signals from the base unit, in the manner described above. The over-the-air RAM software is used during a software update to execute a supplemental software, which in turn is used to update the application software. In one embodiment, the BSL software alone does not have the full capability to update the application software. The BSL software is capable of pulling down the USB RAM software and the over-the-air RAM software, which, once executed, pulls down the application software.

USB display software is used by those handheld units which include a display, such as and LCD display. The USB display software contains specific driver functions for a display, bitmaps, and fonts based on a particular language for a particular hardware revision. The USB RAM software is designed to work with USB display software. USB display software resides in the second computer-readable medium 160b and is accessed by USB RAM software on an as needed basis. The USB RAM software may also be stored in the second computer-readable medium 160b, but in one embodiment it must be transferred over to the first computer-readable medium 160a of the microprocessor for execution.

In one known embodiment, different hardware versions of handheld units 100 may be included in the audience response system, where each version of the hardware device requires a corresponding version of over-the-air RAM software. In one particular embodiment, each version of the handheld unit 100 may execute the same version of the BSL software and the application, provided that the correct over-the-air RAM software has been installed. In alternative embodiments, certain hardware versions of the handheld unit may only be compatible with certain versions of the BSL software and/or the over-the-air RAM software.

In the illustrated embodiment, the second computer-readable medium 160b is shown as empty. However, it should be understood that existing data may be stored on the second computer-readable medium 160b. During the updating process described herein, some existing data on the second computer-readable medium 160b may be written over by new data.

FIG. 5A further illustrates an exemplary series of data packets 520 transmitted in the data transmission 510. Each data packet may include a header with metadata identifying the type of data contained therein. In the illustrated embodiment, an updated USB RAM software is transmitted first, followed by an updated USB display software and an updated BSL software. In one known embodiment, the updated USB RAM software and updated USB display software each have a size of 7 kB and the updated BSL software has a size of 2 kB. However, it should be understood that the data may be of any size. It should also be understood that if the updated USB RAM software, USB display software, or the updated BSL software have a large size, it may be desirable to transmit partial files over multiple data packets.

It should be understood that data packets need not be transmitted in the order in which they are to be processed by a handheld unit. Instead, the data packets may be interspersed (e.g., BSL 1, RAM 1, Display 1, APP 1, BSL 2, RAM 2, APP 2, etc.) Each handheld unit will receive and process the data packet it requires, and ignore the data packets that it does not require. The sequence of the data packets may be dynamically varied. For example, if a large number of handheld units require a specific data packet, that specific data packet may be transmitted more often than the other data packets, until a predetermined number of handheld units acknowledge receipt of that data packet.

After the updated BSL software is transmitted, a first version of updated over-the-air RAM software is transmitted, followed by subsequent versions of updated over-the-air RAM software. In one embodiment, the base unit 200 only transmits versions of updated over-the-air RAM software that correspond to the hardware versions of the handheld units 100 that have gone through the initialization process. In an alternative embodiment, the base unit 200 transmits all known versions of updated over-the-air RAM software.

In one known embodiment, each version of updated over-the-air RAM software has a size of 7 kB. However, it should be understood that the updated over-the-air RAM software be of any size. It should also be understood that if the updated over-the-air RAM software has a large size, it may be desirable to transmit partial files over multiple data packets.

After each version of the updated over-the-air RAM software is transmitted, the updated application is transmitted. In the illustrated embodiment, portions of the application are transmitted over multiple data packets.

In one embodiment, the entire updated application has a size of 128 kB. However, it should be understood that the updated application may be of any size.

The data transmission 510 may be repeated until each of the handheld units 100 acknowledges receipt of each of the required data packets 520. Alternatively, the data transmission 510 may be repeated for a predetermined length of time. Although the data transmission 510 has been described as having particular data packets 520 in a specified order, it should be understood that the packets may be transmitted in any order.

In one embodiment, each data packet 520 is encrypted. Accordingly, each data packet 520 must be decrypted by the processing logic 140 of the handheld unit 100 before it can be written to the memory 160. In an alternative embodiment, one or more of the data packets are not encrypted.

The data transmission 510 described above continues throughout the updating process shown in FIGS. 5B-H, although the data packets 520 contained in the data transmission 510 may dynamically change. For example, if the base unit 200 has determined that a specified number of version 1 handheld units are present, it may stop transmitting version 1 over-the-air RAM software after all of the version 1 handheld units have acknowledged receipt of the version 1 over-the-air RAM software. Additionally, if a new handheld unit goes through the initialization process after the software updating has begun, and the new handheld unit requires a version of over-the-air RAM software that was not previously being transmitted, the base unit 200 may begin transmitting that new version of over-the-air RAM software.

FIGS. 5B-H illustrate one example of the order in which the software may be updated in the memory 160 of a handheld unit 100. As shown in FIG. 5B, the handheld unit receives the data transmission 510 but takes no action until it receives the data packet 520 containing updated USB RAM software. Upon receipt of the updated USB RAM software, the processing logic 140 of the handheld unit 100 writes the updated USB RAM software to the second computer-readable medium 160b. The handheld unit 100 may then send an acknowledgment signal to the base unit 200. In an alternative embodiment (not shown), the processing logic of the handheld unit writes the updated USB RAM software to the first computer-readable medium.

As shown in FIG. 5C, after the processing logic 140 of the handheld unit 100 writes the updated USB RAM software to the second computer-readable medium, it receives the data packet 520 containing the updated BSL software. If the handheld unit 100 receives other data packets prior to the data packet containing the updated BSL software, it takes no action. Upon receipt of the updated BSL software, the processing logic 140 of the handheld unit 100 decrypts and reads the data packet, and writes the updated BSL software to the second computer-readable medium 160b. The handheld unit 100 may then send an acknowledgment signal to the base unit 200. In an alternative embodiment (not shown), the processing logic of the handheld unit writes the updated BSL software to the first computer-readable medium.

After the processing logic 140 of the handheld unit 100 writes the updated BSL software to the second computer-readable medium, it verifies that the updated BSL software is correct. In one known embodiment, verification is performed by a cyclic redundancy check (“CRC”). After verification, the processing logic 140 wipes the old BSL software from the first computer-readable medium. The processing logic 140 then copies the updated BSL software from the second computer-readable medium to the first computer-readable medium, as shown in FIG. 5D.

As shown in FIG. 5E, after the processing logic 140 of the handheld unit 100 writes the updated BSL software to the first computer-readable medium 160a, it receives the data packet 520 containing the updated over-the-air RAM software of a predetermined version corresponding to the hardware version of the handheld unit 100. If the handheld unit 100 receives other data packets prior to the data packet containing the updated over-the-air RAM software of the predetermined version, it takes no action. Upon receipt of the updated over-the-air RAM software of the predetermined version, the processing logic 140 of the handheld unit 100 reads the data packet, and writes the updated over-the-air RAM software of the predetermined version to the first computer-readable medium 160b. The handheld unit 100 may then send an initial acknowledgment signal to the base unit 200. The processing logic 140 then decrypts the updated over-the-air RAM software, and rewrites the decrypted over-the-air RAM software to the first computer-readable medium 160a, and verifies that the updated over-the-air RAM software is complete. The handheld unit 100 may then send a full acknowledgment, identifying the mode of update, as well as image and metadata information. In an alternative embodiment (not shown), the processing logic of the handheld unit writes the updated BSL software to the second computer-readable medium.

As shown in FIG. 5F, after the processing logic 140 of the handheld unit 100 writes the decrypted updated over-the-air RAM software of the predetermined version to the first computer-readable medium 160a, it receives the data packet 520 containing the updated USB display software. If the handheld unit 100 receives other data packets prior to the data packet containing the updated USB display software, it takes no action. Upon receipt of the updated USB display software, the processing logic 140 of the handheld unit 100 reads the data packet, and writes the updated USB display software to the second computer-readable medium 160b. The handheld unit 100 may then send an acknowledgment signal to the base unit 200. In an alternative embodiment (not shown), the processing logic of the handheld unit writes the updated USB display software to the first computer-readable medium.

As shown in FIG. 5G, after the processing logic 140 of the handheld unit 100 writes the decrypted updated over-the-air RAM software of the predetermined version to the first computer-readable medium 160a, it receives the data packet 520 containing the first part of the updated application. If the handheld unit 100 receives other data packets prior to the data packet containing the first part of the updated application, it takes no action. Upon receipt of the first part of the updated application, the processing logic 140 of the handheld unit 100 decrypts and reads the data packet, and writes the first part of the updated application to the first computer-readable medium 160b. The handheld unit 100 may then send an acknowledgment signal to the base unit 200. In an alternative embodiment (not shown), the processing logic of the handheld unit writes the updated first part of the application software to the second computer-readable medium before verifying the first part and writing it to the first computer-readable medium. In such an embodiment, the second computer-readable medium would be used as a “scratchpad.”

The handheld unit 100 then repeats this process for the second part of the updated application, the third part, etc., until the entire updated application has been received. In one embodiment, the handheld unit 100 must write the parts of the updated application to the first computer-readable medium 160a in sequence from 1 to n. In an alternative embodiment, the handheld unit 100 may write the parts of the updated application to the first computer-readable medium 160a in any order.

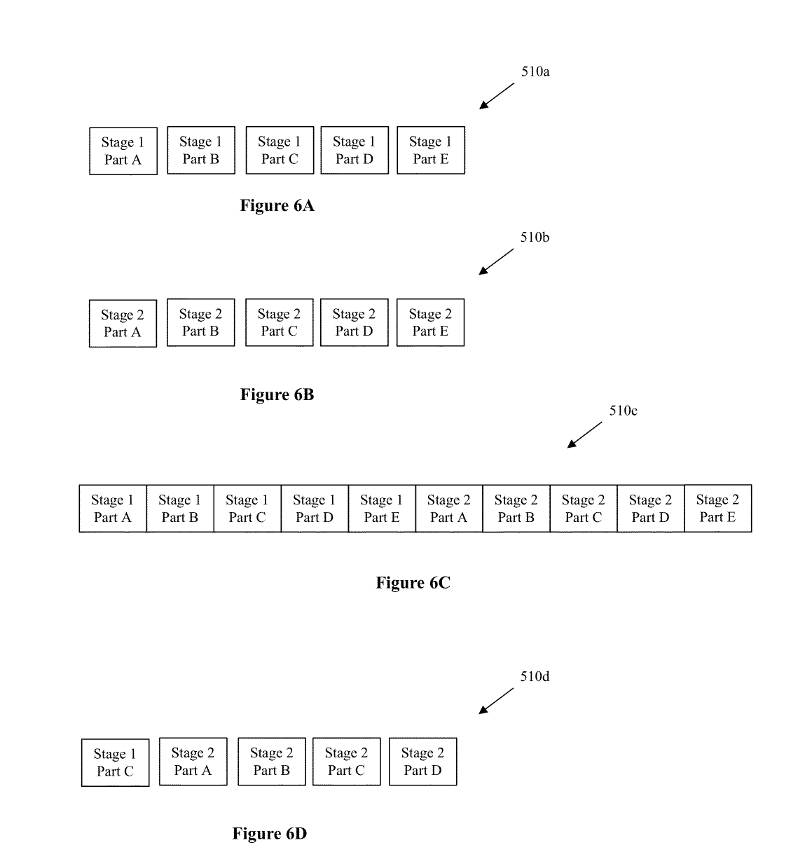

While FIGS. 5A-G illustrate exemplary stages of a specific software update, the teachings may be applied more broadly to any wireless transmission of data—particularly in the transmission of large amounts of data, such as the transmission of a large software in the form of multiple data packets, or the transmission of data packets to multiple devices. FIGS. 6A-D are schematic drawings of exemplary transmissions of data packets for a software being transmitted in stages. In the illustrated example, software is being transmitted in two stages (Stage 1 and Stage 2), with each stage have five data packets (Parts A-E). It should be understood that this example is simplified for convenience of illustration, and that software may have any number of stages, with each stage having any number of parts. It is common for software to be transmitted in thousands of data packets.

FIG. 6A illustrates a first transmission 510a of Stage 1 data packets, including Parts A-E. In one embodiment, the first transmission 510a may be retransmitted repeatedly until acknowledgment is received that the device or devices have received all of Parts A-E of Stage 1.

FIG. 6B illustrates a second transmission 510b of Stage 2 data packets, including Parts A-E. In one embodiment, after an acknowledgment is received that the device or devices have received all of Parts A-E of Stage 1, Parts A-E of Stage 2 are then transmitted repeatedly until acknowledgment is received that the device or devices have received all of Parts A-E of Stage 2.

FIG. 6C illustrates an alternative transmission 510c for another embodiment, where software is being transmitted to multiple devices. In one embodiment, after a predetermined number of devices acknowledge that all of Parts A-E of Stage 1 have been received, the base unit begins transmitting Parts A-E of Stage 2 in combination with Parts A-E of Stage 1. While FIG. 6C shows the parts being transmitted in sequential order, it should be understood that the packets may be transmitted in any order. The Stage 1 and Stage 2 data packets will be transmitted together until all of the devices acknowledge that an entire stage has been received, at which point only the remaining stage will be transmitted.

FIG. 6D illustrates another alternative transmission 510d for yet another embodiment, in which the receiving device or receiving devices acknowledge the receipt of each data packet. In such an embodiment, once all of the receiving devices (or the single receiving device) acknowledge receipt of a specific data packet, that data packet is no longer included in the transmission 510d. Instead, a data packet from the next stage is added to the transmission 510d.

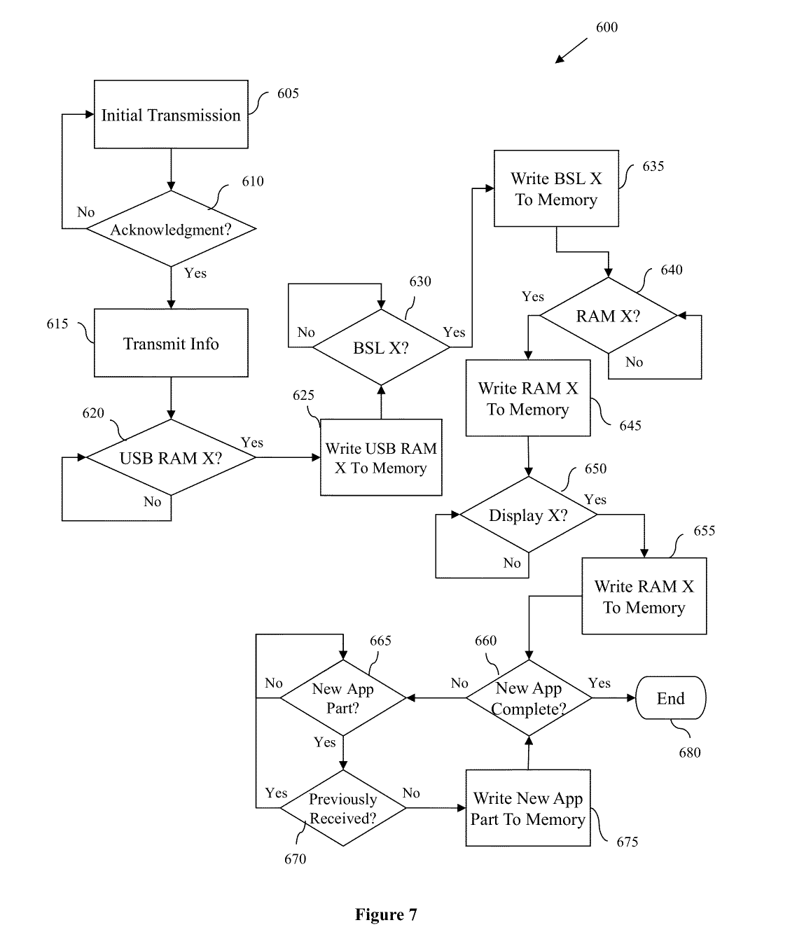

FIG. 7 is a simplified flow chart 600 of one embodiment of a method performed by a handheld units 100 for updating its software. As explained above, the handheld unit 100 first makes an initial transmission (at 605) and waits for an acknowledgment (at 610). If the handheld unit 100 does not receive an acknowledgment within a predetermined amount of time, it resends the initial transmission (at 605) and repeats this process until the acknowledgment is received, or until the handheld unit 100 times out.

After the handheld unit 100 receives an acknowledgment, it transmits information (at 615). Exemplary information includes, without limitation, an application version, a BSL version, a language, a unique address, a hardware version number, and a battery level. In one embodiment (not shown), the handheld unit 100 will retransmit this information until an acknowledgment is received.

After the handheld unit 100 transmits the information, it waits (at 620) for a signal containing an appropriate version X of USB RAM software. The handheld unit 100 may first receive an initial acknowledgment, followed by a larger acknowledgment signal that contains additional information, such as the mode of the software update (e.g., forced, prompt, ineligible, etc.) as well as image and RF metadata information. The handheld unit 100 may also receive other signals in the interim, but will ignore these signals until the USB RAM software is received. After receiving the USB RAM software, the handheld unit 100 writes the USB RAM software to memory (at 625).

After the handheld unit 100 writes the USB RAM software to memory, it waits (at 630) for a signal containing an appropriate version X of BSL software. The handheld unit 100 may receive other signals in the interim, but will ignore these signals until the BSL software is received. After receiving the BSL software, the handheld unit 100 writes the BSL software to memory (at 635).

After the handheld unit 100 writes the BSL software to memory, it waits (at 640) for a signal containing an appropriate version X of over-the-air RAM software corresponding to the version number of the handheld unit 100. The handheld unit 100 may receive other signals in the interim, but will ignore these signals until the over-the-air RAM software corresponding to the version number of the handheld unit 100 is received. After receiving the over-the-air RAM software corresponding to the version number of the handheld unit 100, the handheld unit 100 writes the over-the-air RAM software to memory (at 645).

After the handheld unit 100 writes the over-the-air RAM software to memory, it waits (at 650) for a signal containing an appropriate version X of USB display software corresponding to the version number of the handheld unit 100. The handheld unit 100 may receive other signals in the interim, but will ignore these signals until the USB display software corresponding to the version number of the handheld unit 100 is received. After receiving the USB display software corresponding to the version number of the handheld unit 100, the handheld unit 100 writes the USB display software to memory (at 655).

After writing the USB display software to memory, the handheld unit 100 determines if the updated application is complete (at 660). If the updated application is not complete, the handheld unit 100 waits (at 665) for a signal containing a portion of the appropriate version X of the application. The handheld unit 100 may receive other signals in the interim, but will ignore these signals until a portion of the application is received. After receiving the portion of the application, the handheld unit 100 determines whether the portion of the application has been previously received (at 670). If the portion has been previously received, the handheld unit 100 again waits (at 665) for a signal containing a portion of the application. If the portion has not been previously received, the handheld unit 100 writes the portion of the application to memory (at 675).

After writing the portion of the application to memory, the handheld unit 100 again determines whether the application is complete (at 660) and repeats steps 660-675 until the application is complete. When the application is complete, the updating process ends (at 680).

It should be understood that some or all of the data may be encrypted, and that the handheld unit may decrypt the data prior to writing it to memory. In one embodiment (not shown), the handheld unit 100 transmits a confirmation signal after writing each data packet to memory. The handheld unit 100 may also verify the data packet prior to sending a confirmation signal.

Although the method 600 described above recited steps in a particular order, it should be understood that the order in which types of data is received may be varied. In some embodiments, certain types of data are prerequisites that must be received, written to memory and/or executed, before other types of data can be written to memory. In other embodiments, the data can be received and written to memory in any sequence.

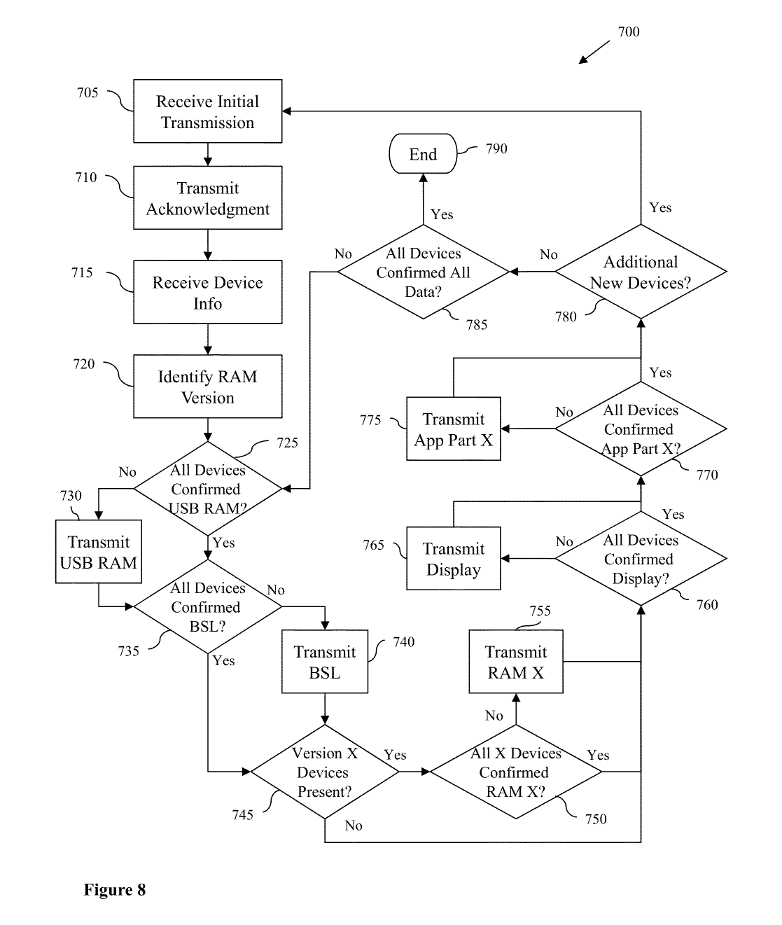

FIG. 8 is a simplified flow chart 700 of one embodiment of a method performed by a base unit 200 for updating software of a plurality of handheld units 100. The base unit 200 receives an initial transmission (at 705) from a handheld unit, and transmits an acknowledgment (at 710). After transmitting the acknowledgment, the base unit 200 receives information from a handheld unit 100 (at 715). Exemplary information includes, without limitation, an application version, a BSL version, language, a unique address, a hardware version number, and a battery level. In one embodiment (not shown), the base unit 200 transmits an acknowledgment in response to receiving information from the handheld unit 100.

After receiving the information from the handheld unit 100, the base unit 200 identifies the version of over-the-air RAM software that it requires (at 720). The base unit 200 determines whether all of the registered handheld units 100 in the system have received USB over-the-air RAM software (at 725). If at least one registered handheld unit 100 has not received the USB RAM software, the base unit 200 transmits the USB RAM software (at 730).

After transmitting the USB RAM software, or after determining that all of the registered handheld units 100 have received the USB RAM software, the base unit 200 determines whether all of the registered handheld units 100 in the system have received the BSL software (at 735). If at least one registered handheld unit 100 has not received the BSL software, the base unit 200 transmits the BSL software (at 740).

After transmitting the BSL software, or after determining that all of the registered handheld units 100 have received the BSL software, the base unit 200 determines whether any first version handheld units are present (at 745). If at least one first version handheld unit is present, the base unit 200 determines whether all of the first version handheld units have received the first version of over-the-air RAM software (at 750). If at least one first version handheld unit has not received the first version of over-the-air RAM software, the base unit 200 transmits the first version of over-the-air RAM software (at 755). The base unit 200 then repeats steps 745-755 for all known versions of handheld units.

After transmitting the over-the-air RAM software, or after determining that all of the registered handheld units 100 have received the over-the-air RAM software, the base unit 200 determines whether all of the registered handheld units 100 in the system have received the USB display software (at 760). If at least one registered handheld unit 100 has not received the USB display software, the base unit 200 transmits the USB display software (at 765).

After the last version of over-the-air RAM software is transmitted, the base unit 200 determines whether all of the handheld units 100 have received the first part of the application (at 770). If at least one handheld unit 100 has not received the first part of the application, the base unit 200 transmits the first part of the application (at 775). The base unit 200 then repeats steps 770-775 for all parts of the application.

After the complete application has been transmitted, the base unit 200 determines if additional new handheld units 100 are present (at 780). If new handheld units 100 are present, the base unit 200 receives an initial transmission (at 705). Although the flowchart 700 shows the receipt of initial transmissions at a specific point of the process, it should be understood that initial transmissions may be received at any time, and that the base unit may transmit acknowledgment (at 710), receive device information (at 715), and identify the over-the-air RAM software version of the new handheld unit (at 720) after the transmission of any data packet. The base unit 200 may then transmit the next data packet in the sequence, instead of beginning again with the transmission of USB RAM software.

If no additional handheld units 100 are present, the base unit 200 determines whether all handheld units 100 have confirmed receipt of all of the data required for the software update (at 785). If at least one handheld unit requires at least one piece of data, the base unit returns to step 725. If all of the handheld units have received all of the data, then the process ends (at 790).

It should be understood that the base unit 200 may receive confirmation signals throughout the process, which indicate that a particular handheld unit has received the data and written it to memory. It should also be understood that one or more of the data packets may be encrypted.

Although the method 700 described above recited steps in a particular order, it should be understood that the order in which types of data is transmitted may be varied. Additionally, certain data packets may be transmitted more frequently. For example, if a disproportionate number of handheld units require the BSL 1 data packet, the BSL 1 data packet may be transmitted more often than other data packets.

It should also be understood that the transmission of data packets may be sectionalized for efficiency. In practice, where a large number of devices are being updated, thousands of data packets may need to be transmitted. When a device has received all but a few data packets, it would be inefficient for the device to wait for thousands of packets to be transmitted before the base unit transmits the needed packets. Accordingly, the base unit may repeatedly transmit a discrete number of packets until all of the devices have received the required packets from that discrete number of packets. The base unit may then repeatedly transmit the next discrete number of packets. Alternatively, the base unit may dynamically add and drop new packets to the group of packets that are being transmitted, as acknowledgments are received.

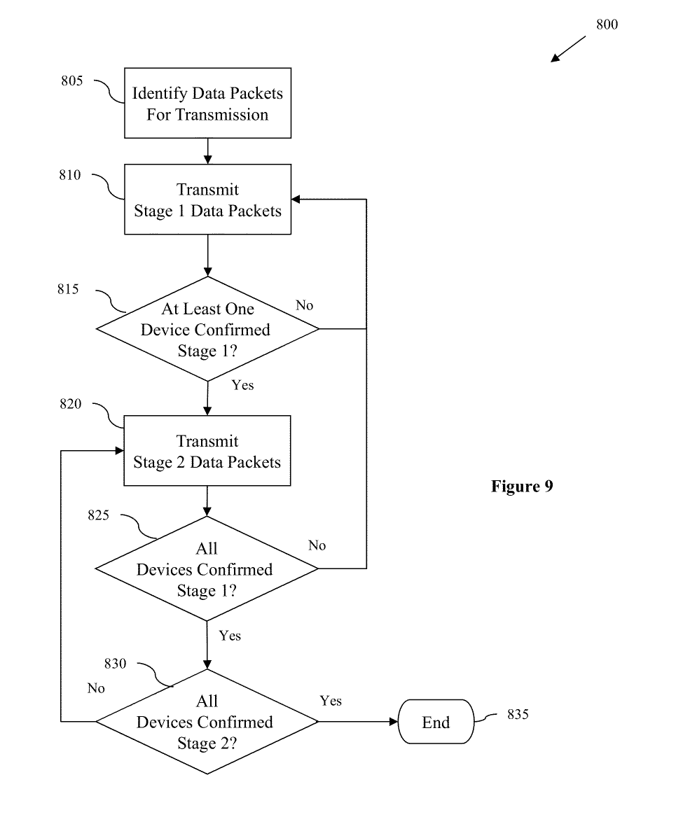

FIG. 9 illustrates a simplified flow chart of one embodiment of a general method 800 for transmitting software in sections. In this simplified example, the software is transmitted in two stages. However, it should be understood that software may be transmitted in any number of stages.

First, a determination is made as to what software is required, and data packets are identified for transmission (at 805). Stage 1 data packets are then transmitted (at 810) and acknowledgments are received from one or more devices. If at least one device confirmed that Stage 1 has been received (at 815), then Stage 2 data packets are transmitted (at 820). If no devices confirmed that Stage 1 has been received (at 815), then only Stage 1 data packets are retransmitted (at 810) until a confirmation is received.

While Stage 2 data packets are being transmitted, acknowledgments continue to be received. If not all of the devices have confirmed receipt of Stage 1 (at 825), then Stage 1 data packets continue to be transmitted (at 810). If all of the devices have confirmed receipt of Stage 2 (at 825), then a determination is made if all of the devices have received Stage 2 (at 830). If not all of the devices have received Stage 2, then Stage 2 data packets are retransmitted (at 820). Once all of the devices have received Stage 2 (at 830), the process ends (at 835).

While example systems, methods, and so on, have been illustrated by describing examples, and while the examples have been described in considerable detail, it is not the intention to restrict or in any way limit the scope of the appended claims to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, and illustrative examples shown or described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. A method of providing a software update to a plurality of transmission devices, the method comprising:
receiving, by a processor, a first information signal containing a first transmission device identifier, a first transmission device hardware version identifier, and a first software version identifier;
wirelessly transmitting a first plurality of data packets in series, wherein each of the first plurality of data packets includes one of a set of data packet identifiers and a portion of an update to software corresponding to the first software version identifier;
receiving, by the processor, at least one data packet acknowledgment; and
wirelessly transmitting a second plurality of data packets, wherein the second plurality of data packets includes at least one previously transmitted data packet for which a data packet acknowledgment has not been received by the processor.

2. The method of claim 1, wherein the second plurality of data packets further includes at least one data packet that has not been previously transmitted that includes one of the set of data packet identifiers and an additional portion of the update to software corresponding to the first software version identifier.

3. The method of claim 1, further comprising receiving a first initial signal by the processor, prior to receiving the first information signal, and wirelessly transmitting a first request for an information signal.

4. The method of claim 1, further comprising:
receiving, by the processor, a second information signal containing a second transmission device identifier, a second transmission device hardware version identifier, and a second software version identifier,
wherein the wirelessly transmitting the first plurality of data packets further includes wirelessly transmitting data packet including one of a second set of data packet identifiers and a portion of an update to software corresponding to the second software version identifier, and
wherein the receiving, by the processor, at least one data packet acknowledgment includes receiving at least one data packet including one of the second set of data packet identifiers and the second transmission device identifier.

5. The method of claim 4, wherein the second transmission device hardware version identifier is different from the first transmission device hardware version.

6. The method of claim 4, wherein the second software version identifier is different from the first software version identifier.

7. The method of claim 1, wherein the wirelessly transmitting the first plurality of data packets includes wirelessly transmitting a first portion of the first plurality of data packets at a first transmission rate, and wirelessly transmitting a second portion of the first plurality of data packets at a second transmission rate different from the first transmission rate.

8. The method of claim 1, wherein the wirelessly transmitting the first plurality of data packets includes wirelessly transmitting at least one data packet at a first transmission rate, and wherein the wirelessly transmitting the second plurality of data packets includes wirelessly transmitting at least one data packet at a second transmission rate different from the first transmission rate.

9. An audience response system comprising:
a transmission device having a first transmission device identifier, a first transmission device hardware version, and a first software version,
wherein the transmission device is configured to transmit a first information signal that includes the first transmission device identifier, a first hardware version identifier corresponding to the first transmission device hardware version, and a first software version identifier corresponding to the first software version,
wherein the transmission device is further configured to transmit an acknowledgment signal in response to receiving data packets; and
a base unit configured to receive the first information signal and transmit a first plurality of data packets, wherein each of the first plurality of data packets includes one of a set of data packet identifiers and a portion of an update to software corresponding to the first software version identifier,
wherein the base unit is further configured to receive a plurality of data packet acknowledgments, and
wherein the base unit is further configured to transmit a second plurality of data packets, including at least one previously transmitted data packet for which a data packet acknowledgment has not been received by the base unit.

10. The audience response system of claim 9, wherein the second plurality of data packets further includes at least one data packet that has not been previously transmitted that includes one of the set of data packet identifiers and an additional portion of the update to software corresponding to the first software version identifier.

11. The audience response system of claim 9, further comprising receiving a first initial signal by the processor, prior to receiving the first information signal, and wirelessly transmitting a first request for an information signal.

12. The audience response system of claim 9, wherein the base unit is in signal communication with an external computer.

13. The audience response system of claim 9, further comprising a second transmission device configured to transmit a second information signal that includes a second transmission device identifier, a second hardware version identifier corresponding to a second transmission device hardware version, and a second software version identifier corresponding to a second software version, and wherein the second transmission device is further configured to transmit an acknowledgment signal in response to receiving data packets.

14. The audience response system of claim 13, wherein the first information signal further includes a first transmission device battery level, and wherein the second information signal includes a second transmission device battery level, and wherein the base unit is further configured to determine whether the first transmission device battery level is above a predetermined threshold and whether the second transmission device battery level is above a predetermined threshold, prior to wirelessly transmitting the plurality of data packets.

15. The audience response system of claim 9, wherein the transmission device is further configured to identify at least a first set of data packets and second set of data packets from the first plurality of data packets, and wherein the transmission device is configured to transmit an acknowledgment signal only in response to receiving all of the data packets of the first set of data packets or all of the data packets of the second set of data packets.

16. An audience response system comprising:
a base unit configured to transmit a plurality of data packets, each data packet including a data packet identifier, and a portion of a software update;
at least one handheld device comprising:
a transceiver configured to receive the plurality of data packets,
a memory having a software stored thereon, and
a processor, configured to erase the software and store each received data packet in the memory of the handheld device, wherein the processor is further configured to, after storing a predetermined number of data packets, decrypt each data packet, and rewrite the decrypted data packet to the memory.

17. The audience response system of claim 16, wherein the at least one handheld device includes a plurality of handheld devices, each of the plurality of handheld devices including a device identifier, a hardware version, and a software version, and wherein each of the plurality of handheld devices is configured to transmit an information signal that includes a device identifier, a hardware version identifier, and a software version identifier, and wherein the base unit is further configured to receive the information signal, and transmit a plurality of data packets corresponding to the device identifier, the hardware version identifier, and the software version identifier.

18. The audience response system of claim 16, wherein the at least one handheld device is further configured to transmit an initial signal prior to receiving a transmission from the base unit.

19. A method of providing a software update to a plurality of transmission devices, the method comprising:
receiving, by a processor, a first information signal containing a first transmission device identifier, a first transmission device hardware version identifier, and a first software version identifier;
wirelessly transmitting a first plurality of data packets in series;
receiving, by the processor, at least one data packet acknowledgment; and
wirelessly transmitting a second plurality of data packets in series,
wherein the second plurality of data packets includes at least one previously transmitted data packet for which a data packet acknowledgment has not been received by the processor, and
wherein the wirelessly transmitting the first plurality of data packets in series and the wirelessly transmitting the second plurality of data packets in series includes wirelessly transmitting at least one data packet at a first transmission rate, and wirelessly transmitting at least one data packet at a second transmission rate different from the first transmission rate.

20. The method of claim 19, further comprising determining at least one of the first transmission rate and the second rate based on the first transmission device hardware version identifier.

21. The method of claim 19, wherein the wirelessly transmitting at least one data packet at the second transmission rate is based on a determination that a data packet acknowledgment has not been received.
